(19) United States
(12) Patent Application Publication
(10) Pub. No.: US 2013/0000585 A1
(43) Pub. Date: Jan. 3, 2013

(54) STARTER SUPPLY NETWORK

(76) Inventors: Matthias Cwik, Stuttgart (DE); Falco Sengebusch, Stuttgart-Feuerbach (DE)

(21) Appl. No.: 13/511,913

(22) PCT Filed: Sep. 27, 2010
(86) PCT No.: PCT/EP2010/064234

§ 371 Date: Sep. 19, 2012

(30) Foreign Application Priority Data
Nov. 26, 2009 (DE) 102009047177.4

(51) Int. Cl. H02P 1/00; F02N 11/08

(52) U.S. Cl. 123/179.3; 318/139

(57) ABSTRACT

A starter supply network having a first energy source for the primary energy supply of a starter motor, the first energy source being coupled to a network terminal of the starter supply network; a second energy source; and a coupler, which is configured to couple the second energy source to the network terminal as a function of a starter motor current delivered by the first energy source, in order to counteract a reduction in the starter motor current.

### FIELD OF THE INVENTION

The present invention relates to the area of starter systems in motor-vehicle drive units

### BACKGROUND INFORMATION

In modern motor-vehicle drive units, so-called starter motors, which normally take the form of electric motors, are used for starting a primary source of propulsion, for example, an internal combustion engine. The task of a starter motor is to speed up the internal combustion engine to a minimum rotational speed, in order that the combustion process can proceed independently and stable idling can be achieved solely by the combustion process.

Starter supply networks or vehicle electrical systems, which are made up of, as a rule, a battery, the starter motor, and a lead wire that connects the battery to the starter motor, are normally used for supplying the starter motor with electrical energy.

To start the combustion engine, a switching contact, which directly connects the starter motor to the battery via the lead wire, is closed in response to an existing starting request of the driver. However, after a maximum current in the first starting instant, the current falls rapidly again, since the commencing rotation of the starter motor induces a voltage, which is opposite to the voltage induced on the outside. After a minimum rotational speed of the combustion engine is reached, it is brought over into automatic operation, to which end the switching contact is opened and the starting operation is ended.

One of the target criteria in the design of a starter system and a combustion engine is to minimize the starting time, that is, the time from the beginning of the start to the reaching of a particular rotational speed threshold value by the combustion engine. To this end, the power supplied to the combustion engine by the starter may be increased, for example, which, however, results in a greater starting current. In this manner, e.g., in the case of a permanent-magnet d.c. motor as a starter motor, the permanent magnets may be demagnetized, which results in a permanent reduction in efficiency of the starter motor. The higher starting current, i.e., starter current, also results in a higher torque of the starter motor, for which the individual components of the starter motor may not be designed, which means that increased wear or even destruction of the starter motor are to be expected. In addition, the starter motor may reach an idling speed that is too high, in which case the resulting centrifugal forces may contribute to its destruction. To be sure, it is always possible to regulate a starter power output, using power electronics. However, this is associated with circuit engineering expenditure and the increased costs connected with that.

### SUMMARY

In accordance with the present invention, a second energy source, for example, a second voltage source, is integrated into the starter supply network as a starter aid. The second energy source may take the form of a battery or a capacitor, for example. The two voltage sources are preferably to be connected in such a manner, that the starter is energized by one voltage source of the starter, and that after the starter current has dropped to a particular level, the second energy source is subsequently connected to it or brought into circuit instead. The second energy source may be selected, for example, so that after connection, the starter current is greater than prior to connection of the second energy source. In addition, the switching instant may be selected so that a second current spike does not result in demagnetization of the permanent magnets. In this manner, it is possible to transmit more power than before, without demagnetization taking place, the maximum torque of the starter motor being exceeded, or the idling speed becoming too high.

According to one aspect, the present invention relates to a starter supply network having a first energy source for the primary power supply of a starter motor, the first energy source being coupled to a network terminal of the starter supply network; a second energy source; and a coupler, which is configured to couple the second energy source to the network terminal as a function of a starter motor current generated by the first energy source, in order to counteract a reduction in the starter motor current. The starter motor is preferably started with the aid of the first energy source; the second energy source being connected to it after the starting operation, in order to increase the starter motor current, for example.

According to one specific embodiment, the coupler is configured to couple the second energy source to the network terminal in response to a particular current threshold value being reached, not being reached, or being exceeded by the starter motor current. In this manner, it is advantageously ensured that the second energy source is only connected when, for example, the starter motor current falls. The second energy source may be connected, for example, in order to offset the falling of the starter motor current.

According to one specific embodiment, the coupler is configured to couple the second energy source to the network terminal after passage of a particular time interval after the reaching of a certain current value by the starter motor current, for example, after the reaching of a short-circuit current value. In this manner, it is advantageously ensured that the first energy source is assisted by the second energy source.

According to one specific embodiment, the coupler is designed for measuring an output voltage of the starter supply network, for example, a starter motor voltage or an output voltage of the first energy source, as well as an output voltage of the second energy source; and for coupling the second energy source to the network terminal only if the output voltage of the second energy source is not less than, preferably greater than or equal to, the output voltage of the starter supply network. In this manner, it is advantageously ensured that the first energy source or the starter motor is not additionally loaded by the connection of the second energy source. The network terminal may form, for example, an output for outputting the starter motor current. However, the primary energy source, e.g., a starter battery, and/or the second energy source, may also be charged through the network terminal with the aid of an electric generator, for example.

According to one specific embodiment, the coupler is configured to couple the second energy source to the network terminal in order to increase the starter motor current. This advantageously allows the starter motor to be additionally supplied with energy after it is started.

According to one advantageous, specific embodiment, the coupler includes a controllable switch, for example, a transistor switch, which is configured to couple the second energy source to the network terminal. The transistor switch may be, for example, a power transistor switch, so that it may be advantageously ensured that the second energy source can be electrically loaded in a rapid manner.

According to an advantageous specific embodiment, the coupler includes two switches connected in series, in particular, transistor switches, which are designed to couple the second energy source to the network terminal; current being suppliable to the starter motor via an output terminal between the two switches connected in series. In this manner, it is ensured that a further switch, which allows the first energy source to be disconnected, is provided between the output terminal and the network terminal.

According to one advantageous specific embodiment, the coupler is configured to couple the second energy source via a diode. The diode may be connected, for example, in the forward direction, which means that an effect of the starter on the second energy source is decreased. However, the diode may also be connected in the reverse direction, through which it is advantageously ensured that after the second energy source is connected, its charge is not fed into the starter supply network. In this case, the starter motor current may be output through a terminal between the switch and the diode.

According to one advantageous specific embodiment, the first energy source is a starter motor battery for primarily supplying the starter motor with energy. However, the second energy source may be an additional battery or a capacitor.

According to a further aspect, the present invention relates to a starter motor system having a starter motor and the starter supply network of the present invention for supplying the starter motor with electrical energy.

According to a further aspect, the present invention relates to a method for starting a starter motor of a vehicle drive unit, having the step of supplying the starter motor with a starter motor current from a first energy source for starting the starter motor, and the step of connecting a second energy source as a function of the starter motor current in order to counteract a decrease in the starter motor current.

Further exemplary embodiments are explained in more detail with reference to the figures.

### BRIEF DESCRIPTION OF THE DRAWINGS

FIG. 1 shows a starter supply network.

FIG. 2 shows a starter supply network.

FIG. 3 shows a starter supply network.

FIG. 4 shows simulated starter motor currents.

### DETAILED DESCRIPTION OF EXAMPLE EMBODIMENTS

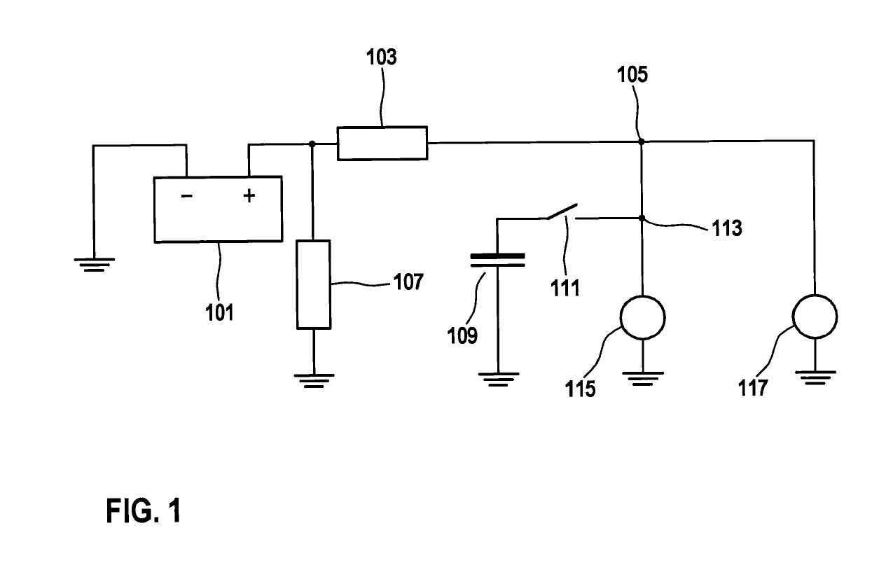

FIG. 1 shows a starter supply network having a first energy source 101, which is coupled to a network terminal 105 via a line resistor 103, for example. In addition, a terminal of first energy source 101 is connected to ground through a resistor 107. The starter supply network further includes a second energy source 109, e.g., a capacitor, which may be coupled to network terminal 105 by a coupler 111, for example, a switch. An output of switch 111 forms a terminal 113, to which, for example, a starter motor 115 is connectible. A generator 117 may also be connected to network terminal 105. Terminal 113 is connected to network terminal 105.

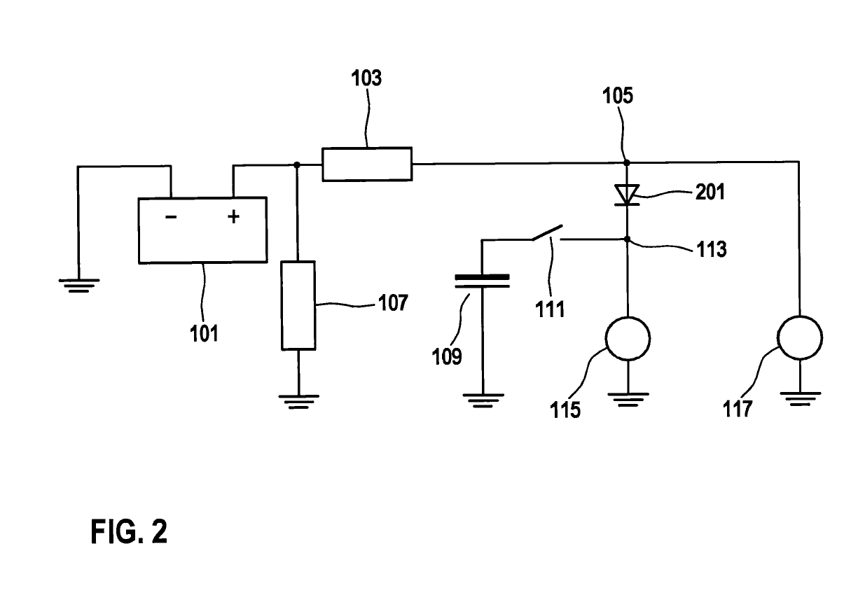

FIG. 2 shows a starter supply network, in which in contrast to the starter supply network represented in FIG. 1, a diode 201 operated in the reverse direction is connected between terminal 113 and network terminal 105. When second energy source 109 is connected, this prevents charge from leaking off into the direction of the first energy source, that is, in the direction of the starter supply network. In this manner, it is advantageously ensured that energy stored in the second energy source is completely available to starter motor 115. However, according to a further specific embodiment, diode 201 may also be connected in the forward direction, through which the starter current obtained from first energy source 101 is prevented from unintentionally flowing off to charge second energy source 109. In order to charge second energy source 109, a further switch may also be provided, for example, a parallel switch, which is closed after the starting of starter motor 115, preferably only to charge second energy source 109.

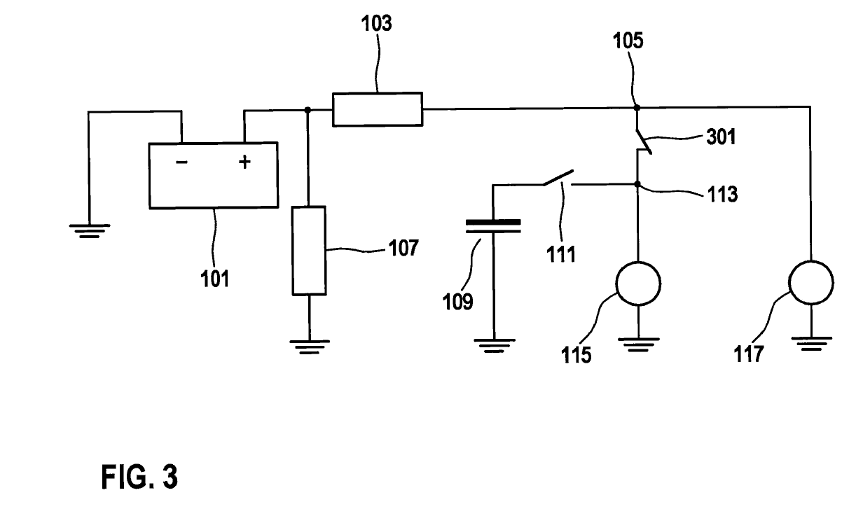

FIG. 3 shows a starter supply network, in which in contrast to the starter supply network represented in FIG. 1, a further switch 301 is situated between terminal 113 and network terminal 105. This allows a switchover time, at which, e.g., first energy source 101 may be disconnected, to be freely selected in an advantageous manner.

The second energy source should preferably be selected in such a manner, that it contributes to an additional starter current during the starter operation. This may be ensured, for example, by a suitably selected capacitor, which may store markedly more energy than is necessary for boosting the starter current. In addition, switch 111 may be activated only when the voltage level of the second energy source is greater than at starter motor 115. For this, e.g., an additional differential voltage measurement may be taken, for example, with the aid of a differential voltage measuring device not shown in FIGS. 1 through 3.

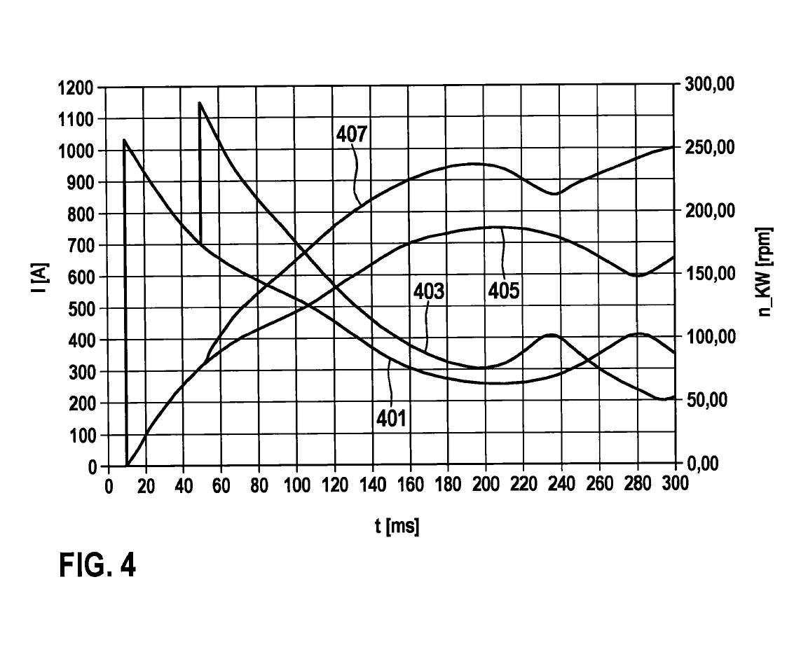

FIG. 4 shows simulated curves of starter motor currents 401 and 403 and corresponding motor rotational speeds 405 and 407. In this context, starter motor curve 401 and motor rotational speed curve 405 correspond to the conventional approach for starting the starter motor. Starter motor current curve 403, as well as corresponding motor rotational speed 407, are produced when using the design of the present invention.

The starting operation may begin as usual, for example, using first energy source 101, e.g., using a lead acid battery. In the first instant, the starter current increases to a maximum short-circuit value of approximately 1000 A. However, this current decreases along starter current curve 401 with the setting-in rotation of the starter motor. After a certain time, for example, after approximately 50 ms, the second energy source is preferably connected in parallel in direct proximity to the starter motor; second energy source 109 being able to be a fully charged capacitor. In this manner, the starter current increases, for example, to a value greater than 1100 A, through which the starter current along starter current curve 403 is established. By connecting the second energy source, the starter current increases, which means that the combustion engine, which is driven by the starter motor, may speed up more rapidly. This produces a time advantage during the starting operation.

The time at which the second energy source is switched into the circuit may be determined as a function of the layout of the starter supply network, in which, for example, the voltage levels and internal resistances of the energy sources, e.g., voltage sources, the lead wire resistances, as well as the run-up behavior of the starter motor, may be taken into consideration. Different strategies are possible for this. Thus, the second energy source may be brought into circuit, for example, after a fixed time, e.g., 50 ms, after reaching a short-circuit current. The second energy source may be further brought into circuit after the starter current has fallen below a particular threshold current value, for example. The second energy source may also be brought into circuit after the battery terminal voltage, that is, the output voltage of the second energy source, has exceeded a particular threshold value.

The curves shown in FIG. 4 illustrate a simulated start of a diesel engine at an output voltage of the first energy source of 11.7 V, an internal resistance of the first energy source of 3.75 mOhm at 0° C., with 25% Qv and 80% SOC. The output voltage of the second energy source was 14.4 V at an internal resistance of 2.5 mOhm and a temperature of 124° F.

1-11. (canceled)

12. A starter supply network, comprising:
a first energy source for primary energy supply of a starter motor, the first energy source being coupled to a network terminal of the starter supply network;
a second energy source; and
a coupler configured to couple the second energy source to the network terminal as a function of a starter motor current delivered by the first energy source to counteract a decrease in the starter motor current, wherein the coupler is configured to couple the second energy source to the network terminal after passage of a particular time interval after a reaching of a short-circuit current value.

13. The starter supply network as recited in claim 12, wherein the coupler is configured to couple the second energy source to the network terminal in response to one of a particular current threshold value being reached, not being reached, or being exceeded by the starter motor current.

14. The starter supply network as recited in claim 13, wherein the coupler is configured to couple the second energy source to the network terminal after passage of the particular time interval after the reaching of a particular current value by the starter motor current, the particular current value being the short-circuit current value.

15. The starter supply network as recited in claim 13, wherein the coupler measures an output voltage of the starter supply network, and an output voltage of the second energy source, and to couple the second energy source to the network terminal only if the output voltage of the second energy source is not less than the output voltage of the starter supply network, wherein the output voltage of the starter supply network is one of a starter motor voltage or an output voltage of the first energy source.

16. The starter supply network as recited in claim 12, wherein the coupler is configured to couple the second energy source to the network terminal to increase the starter motor current.

17. The starter supply network as recited in claim 12, wherein the coupler has a controllable transistor switch.

18. The starter supply network as recited in claim 12, wherein the coupler has two transistor switches connected in series which couple the second energy source to the network terminal, and the starter motor current may be output through an output terminal between the two switches connected in series.

19. The starter supply network as recited in claim 12, wherein the coupler is configured to couple the second energy source to the network terminal via a diode connected one of in a forward direction or in a reverse direction.

20. The starter supply network as recited in claim 12, wherein the first energy source is a starter motor battery, and the second energy source is a capacitor.

21. A starter motor system, comprising:
a starter motor; and
a starter supply network for supplying the starter motor with electrical energy, the starter supply network including a first energy source for primary energy supply of a starter motor, the first energy source being coupled to a network terminal of the starter supply network, a second energy source, and a coupler configured to couple the second energy source to the network terminal as a function of a starter motor current delivered by the first energy source to counteract a decrease in the starter motor current, wherein the coupler is configured to couple the second energy source to the network terminal after passage of a particular time interval after a reaching of a short-circuit current value.

22. A method for starting a starter motor of a vehicle drive unit, comprising:
providing the starter motor with a starter motor current from a first energy source for starting the starter motor; and
connecting a second energy source as a function of the starter motor current to counteract a decrease in the starter motor current.
